(19) United States
(12) Patent Application Publication
(10) Pub. No.: US 2023/0033499 A1
(43) Pub. Date: Feb. 2, 2023

(54) SIGHTING DEVICE BASED ON CAMERA

(71) Applicant: Eric Todd KLINE, Steinenbronn (DE)

(72) Inventor: Eric Todd KLINE, Steinenbronn (DE)

(21) Appl. No.: 17/497,228

(22) Filed: Oct. 8, 2021

(30) Foreign Application Priority Data
Jul. 27, 2021 (KR) 10-2021-0098466

(51) Int. Cl. F41G 3/16; H04N 5/225; H04N 7/18; H04N 5/232

(52) U.S. Cl. CPC F41G 3/165; H04N 5/2257; H04N 5/232121; H04N 7/183

(57) ABSTRACT

According to an embodiment of the present invention is an sighting device based on camera comprising a camera module and a display module, wherein the camera module comprises main body, photographing unit mounted on the main body to photograph a target, flip cover for opening and closing the open side of the main body, infrared light emitting device installed in a predetermined area of the open side, laser light emitting device installed in a predetermined area of the open side and a first short-range communication module for short-range wireless communication, wherein the display module comprises screen for reproducing the image captured by the camera module in real time or near real time, manipulation unit for manipulating the image reproduced on the screen and a second short-range communication module communicated with the camera module.

This application claims the benefit under 35 USC § 119(a) of Korean Patent Application No. 10-2021-0098466 filed on Jul. 27, 2021 in the Korean Intellectual Property Office, the entire disclosure of which is incorporated herein by reference for all purposes.

### BACKGROUND

### 1. Field

At least on example embodiment relates to a sighting device based on camera and more particularly, to a sighting device based on camera for rifle-mounted targeting devices.

### 2. Description of Related Art

Modern warfare is increasingly focused on avoiding direct combat for neutralizing targets by establishing an automatic system with intelligence such as smart guns to prevent enemies from penetrating by making the best defense in advance. In the case of advanced defense countries, technology is being advanced, with dangerous missions being carried out by specially built robots. In this trend, various methods are being studied to eliminate the traditional risk of being attacked by exposure to position when soldiers are directly in the same position as guns.

Usually, a gun is a device that strikes a target through a warhead fired by explosive force using a gunpowder for the purpose of damaging or destroying the target. It is mainly used for military purposes, and a sighting device is installed at the top for accurate aiming of the target. In other words, the gun consists of a detonator that ignites the warhead to be fired by an explosion, a firing device that guides the direction the warhead is heading towards and rotates to improve its hit rate, and a sighting device to aim the target at the top of the firing device.

Guns are usually direct firearms, with bullets fired from firearms and observation lines extending in a straight line. In particular, there is a problem in which one has no choice but to expose oneself to the target in order to identify the target located on the opposite side of the corner.

This is a very dangerous situation for a person who is in a firefight or tactical situation, so it is very important to have a device that identifies the enemy’s position without exposing the operator.

In addition, the aiming scope, sighting is a device for identifying distant enemies, such as a sighting telescope, extends around the target through a combined lens and allows the enlarged target to be accurately aimed at a distance, providing a sight to the aimer.

However, in order to identify the enemy’s position with the aiming scope, the aiming scope is aligned with the direction of the firearm’s launch, must be directed toward the enemy and then identified. Even in this case, there is a risk of exposure to one’s position.

Therefore, it was required to develop a sighting device capable of accurately targeting and striking a target while maintaining concealment and cover.

Recently, using the principle of a telescope that can observe distant objects at close range, while adjusting the magnification by a combination of various types of lenses, magnify a distant target and aim in the same state as aiming at a short distance, a aiming scope is being used.

These aiming scope is installed so that the user adjusts the refraction magnification by manipulating the lens group to magnify a distant target, and to improve the accuracy of shooting by shooting in the magnified state.

In addition, the refractive firearms, also known as corner shots, have been developed to track and monitor the target even in a hidden state using cover, and to aim fire at the target if necessary.

However, when the barrel (barrel) and the handle of the gun are bent in a foldable manner, a durability of the gun is reduced, it takes a long time to aim because it has to be aimed in a bent state, accuracy is lowered and repeated fire is rendered inaccurate due to the recoil.

In addition, there is a problem in that it cannot be used with non-foldable firearms because it is manufactured as one piece.

### SUMMARY

The purpose of this invention is to provide a camera-based shooting device that can aim guns even under the concealed or covered state.

According to an embodiment of the present invention is an sighting device based on camera comprising a camera module and a display module, wherein the camera module comprises main body, photographing unit mounted on the main body to photograph a target, flip cover for opening and closing the open side of the main body, infrared light emitting device installed in a predetermined area of the open side, laser light emitting device installed in a predetermined area of the open side and a first short-range communication module for short-range wireless communication, wherein the display module comprises screen for reproducing the image captured by the camera module in real time or near real time, manipulation unit for manipulating the image reproduced on the screen and a second short-range communication module communicated with the camera module.

The sighting device further comprises a connector coupled to one surface of the main body to connect the main body and the gun.

The sighting device further comprises an eye cover attached to the screen to enable monocular aiming.

The eye cover comprises focus lens on the inside.

The camera module further comprises a processor for adjusting a focal length or controlling an operation of the infrared light emitting device or the laser light emitting device and a light receiving sensor for detecting the intensity of a neighboring light.

The camera module further comprises a tilt sensor.

According to some example embodiments, the aforementioned sighting device based on camera can aim, track, and monitor a target even in a state in which the body is hidden using cover.

In addition, even when aiming, it is possible to accurately aim the target by the scale displayed on the display.

Furthermore, it can be attached to different types of firearms, and can be attached to a location desired by the user.

Other features and aspects will be apparent from the following detailed description, the drawings, and the claims.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a perspective view of a camera module of a camera-based sighting device according to an embodiment of the present invention.

FIG. 2 is a perspective view of a display module according to an embodiment of the present invention.

FIG. 3 is a perspective view of the eye cover according to an embodiment of the present invention.

FIG. 4 and FIG. 5 are a picture of the actual gun connected to the camera module body and the gun.

FIG. 6 is a view showing an example of actual use of a firearm equipped with a sighting device according to an embodiment of the present invention according to an embodiment of the present invention.

FIG. 7 is an example of combining a camera module and a display module according to another embodiment of the present invention.

### DETAILED DESCRIPTION

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

The following detailed structural or functional description of example embodiments is provided as an example only and various alterations and modifications may be made to the example embodiments. Accordingly, the example embodiments are not construed as being limited to the disclosure and should be understood to include all changes, equivalents, and replacements within the technical scope of the disclosure.

Unless the context clearly indicates otherwise, like reference numerals refer to like elements used throughout. Also, components used herein, such as, for example, terms “-unit/module,” etc., may be implemented as software and/or hardware. Depending on example embodiments, each component with “-unit/module,” etc., may be implemented as a single piece of software, hardware and/or a desired part, and also may be implemented as a plurality of pieces of software, hardware, and/or desired parts.

It should be noted that if it is described that one component is “connected,” “coupled,” or “joined” to another component, a third component may be “connected,” “coupled,” and “joined” between the first and second components, although the first component may be directly connected, coupled, or joined to the second component. On the contrary, it should be noted that if it is described that one component is “directly connected,” “directly coupled,” or “directly joined” to another component, a third component may be absent. Expressions describing a relationship between components, for example, “between,” directly between,” or “directly neighboring,” etc., should be interpreted to be alike.

The singular forms “a,” “an,” and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Terms, such as first, second, and the like, may be used herein to describe components. Each of these terminologies is not used to define an essence, order or sequence of a corresponding component but used merely to distinguish the corresponding component from other component S). For example, a first component may be referred to as a second component, and similarly the second component may also be referred to as the first component. As used herein, the term “and/or” includes any and all combinations of one or more of the associated listed items.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, a sighting device based on camera according to an embodiment of the present invention will be described in detail with reference to the drawings.

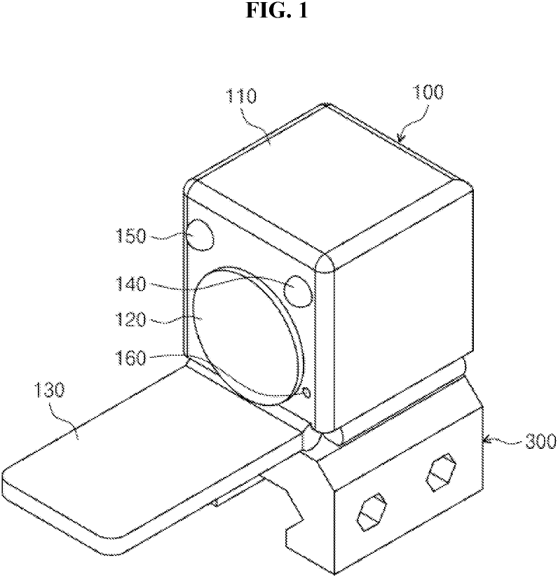

FIG. 1 is a perspective view of a camera module of a camera-based sighting device according to an embodiment of the present invention.

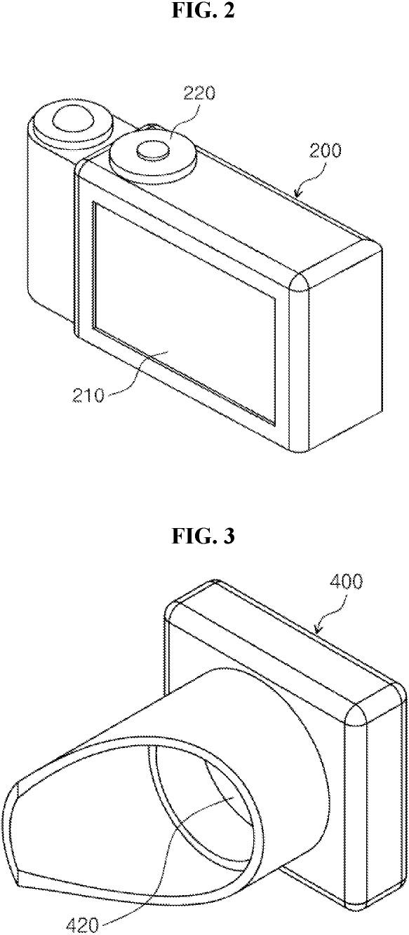

FIG. 2 is a perspective view of a display module according to an embodiment of the present invention.

As shown in FIGS. 1 and 2, the sighting device based on camera is an aiming device including a camera module (1000 and a display module (200) , and the camera module (100) includes a body (110) and the body (110). mounted on a photographing unit (120) for photographing a target, a flip cover (130) for opening and closing an open side of the main body 110, an infrared light emitting device (140) installed in a predetermined area of the open side, the above a laser light emitting device (150) installed in a predetermined area of the open side; and a first short-range communication module (not shown) for short-range wireless communication, wherein the display module (200) is a screen (210) that reproduces an image captured by the camera module (100), and the screen (210) is displayed on the screen (210). It includes a manipulation unit (220) for manipulating the reproduced image and a second short-range communication module (not shown) for performing wireless communication with the camera module (200).

In addition, the camera-based sighting device according to an embodiment of the present invention further includes a connector (300) coupled to one surface of the main body to connect the main body (110) and the firearm.

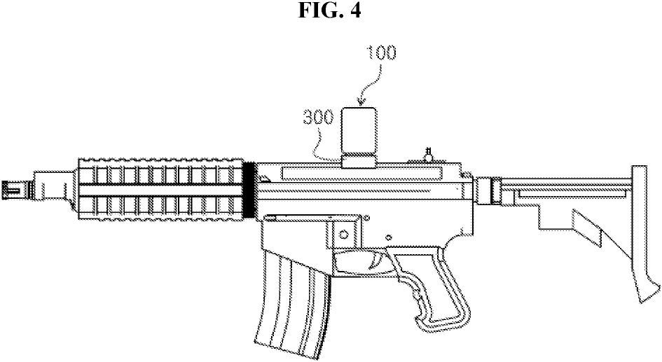

FIG. 3 is a perspective view of an eye cover according to an embodiment of the present invention.

As shown in FIG. 3, the sighting device based on camera according to an embodiment of the present invention further includes an eye cover (400) attached to the screen (210) to enable monocular aiming, and the eye cover (400) has an inner side. It includes a focus lens (420). The Eye cove also allows the light from the video screen to be only seen by the operator when in use.

The camera module (100) shown in FIG. 1 includes a body (110) that is integrally and rigidly configured. The main body (110) is configured such that one side is opened to enable shooting toward the target.

The body (110) may be made of a durable metal material, but is not necessarily limited thereto. In addition, the inside of the main body (110) includes electronic devices necessary for image capturing in various environments, such as a camera module and a sensor.

In particular, heat resistance and moisture resistance are guaranteed due to the utilization characteristics of the aiming device according to the embodiment of the present invention, and it is preferable to be manufactured to be waterproof even at a depth of several meters so that operation is possible even in water, beyond the level of life waterproofing.

The camera module (100) according to an embodiment of the present invention includes a photographing unit (12)0 mounted on a main body (110) to photograph a target.

The photographing unit (120) is a device that converts an optical image of a target into an electrical signal, and converts information such as brightness and color of light into an electrical signal for storage or transmission to the display module 200.

The image sensor included in the photographing unit(120) is a photoelectric conversion device integrated into an integrated circuit using semiconductor device manufacturing technology. As the photographing unit(120) according to an embodiment of the present invention, a CCD image sensor or a CMOS image sensor may be used.

In addition, since the photographing unit(120) includes at least one or more lenses, various image effects such as obtaining a clear image or adjusting the angle of view may be produced.

The flip cover(130) is a customized plate for opening and closing one open side of the main body(110), and is installed to cover one side of the main body (110), in particular an optically open surface for target shooting, and the main body with a hinge. (110) and the flip cover (130) are connected so that one side of the body (110) is opened or closed through the rotation of the flip cover (130).

The infrared light emitting device (140) according to an embodiment of the present invention is installed on one open side of the body (110). It is installed in a position that can be closed and opened by the flip cover (130) described above, and is a light source that operates in a dark state where the target cannot be visually seen to detect the target. In particular, when the infrared light emitting device (140) operates, the above-described photographing unit (120) may operate as an infrared camera capable of detecting infrared light. In general, the infrared light emitting device (140) may be manufactured using an LED device, and the infrared light emitting device (140) irradiates infrared light having a wavelength in an invisible region as a light source.

The laser light emitting device (150) according to an embodiment of the present invention is installed on an open side of the main body (110) like the infrared light emitting device (140) described above. In addition, it is installed in a position that can be sealed and opened by the flip cover (130), and utilizes the straight-line characteristic of the laser light to aim the target.

Although it is known that the general laser oscillation wavelength range is 0.1 µm to 1 mm, it is preferable that the range actually utilized in the present invention is laser light having an oscillation wavelength of 200 µm to 400 µm.

The camera module (100) according to the embodiment of the present invention includes a first short-range communication module (not shown), transmits image information to the display module (200) to be described later, and controls operation from the display module (200). The signal can be received.

The first short-range communication module is, for example, Wi-Fi, Zigbee, Bluetooth, Wi-Fi Direct, NFC (Near Field Communication), low-power Bluetooth (Bluetooth) Low Energy) or CAN communication. In particular, it is preferable that the first short-range communication module be Bluetooth capable of low-power wireless connection in an ultra-short distance of about 10 meters.

The camera module (100) according to an embodiment of the present invention detects the intensity of ambient light and a processor (not shown) that adjusts a focal length or controls the operation of the infrared light emitting device (140) or the laser light emitting device (150) It further includes a light receiving sensor (160), and includes a tilt sensor (not shown).

The processor according to an embodiment of the present invention adjusts the focal length of the target to adjust the camera module (100) so that the target can be clearly photographed, and determines the brightness level of the surroundings through the light receiving sensor (160) to generate an infrared light emitting device (140) can be turned on and off.

In addition, the processor performs rotation conversion of the image data transmitted to the display module (200) in consideration of the rotation state of the camera module (100) recognized through the tilt sensor.

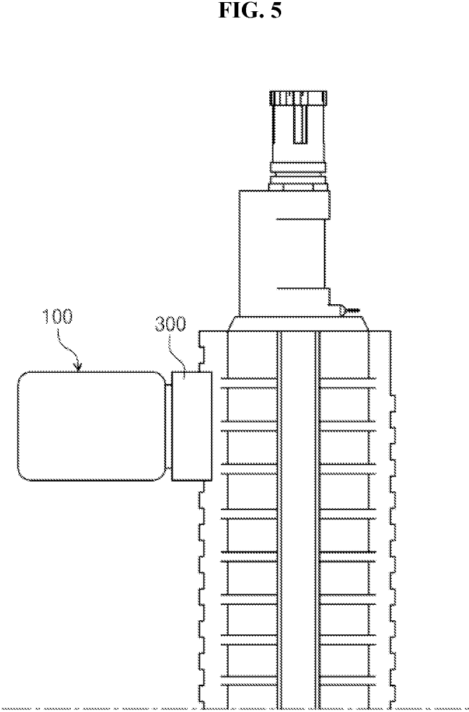

For example, referring to FIGS. 4 and 5, which will be described later, the camera module (100) takes an image inverted upside down depending on the position where the connection connector (300) is connected to the firearm, and the processor is tilted through the tilt sensor. By determining the degree, corrected image data obtained by rotating the image is generated and transmitted to the display module (200).

The processor may include, for example, CPU(Central Processing Unit), MCU(Micro Controller Unit), Micro Processor, AP(Application Processor), ECU(Electronic Controlling Unit) and/or an arithmetic/control unit capable of various arithmetic processing and generation of control signals.

The display module 200 shown in FIG. 2 can be attached to a gun, a helmet, etc., and can be attached and detached at various locations according to the user’s convenience

As shown in FIG. 2, the display module according to an embodiment of the present invention includes a screen.

The screen (210) according to an embodiment of the present invention refers to a small display that receives and reproduces an image captured by the camera module (100) through the first short-range communication module or wire.

In addition, the manipulation unit (220) according to an embodiment of the present invention is a component for manipulating the image reproduced on the screen (210), and enlarges or reproduces the image, changes the target within the image, or changes the image to an infrared photographed image. A variety of operations can be performed.

The operation unit (220) changes the shooting mode of the camera module (100) by pressing a button or using a toggle switch, or finds a camera module that can be connected between short-distance communication modules, and enables connection between devices.

For example, a nearby commander who commands 10 soldiers when 10 soldiers with firearms are performing the monitoring of the target by pointing the camera module (100) according to the embodiment of the present invention at each location can selectively or at once check the area monitored by 10 soldiers through their display module (200).

This is possible by connecting all of the camera modules (100) that can be paired by using the operation unit (220) or by selecting and connecting some of the camera modules.

The second short-range communication module (not shown) may be the same type of communication module as the first short-range communication module described above, preferably Bluetooth.

In addition, the display module (200) according to an embodiment of the present invention further includes a storage unit for storing an image file photographed and received by the camera module (100).

The storage unit may include, for example, at least one of a main memory device and an auxiliary memory device. The main memory device may be implemented using a semiconductor storage medium such as ROM and/or RAM. The ROM may include, for example, a conventional ROM, an EPROM, an EEPROM and/or a Mask-ROM, and the like. The RAM may include, for example, DRAM and/or SRAM. The auxiliary memory device may be a flash memory device, an SD card, or the like.

In addition, although not installed in the display module (200), as a storage device of an external server, it may be implemented using at least one storage medium capable of permanently or semi-permanently storing data; which is such as a solid state drive, a hard disk drive, a magnetic drum, a CD , a DVD, an optical recording medium as a laser disk, a magnetic tape, a magneto-optical disk, a floppy disk, etc.

The connecting connector (300) according to the embodiment of the present invention serves to connect the above-described body (110) and the firearm.

The connecting connector (300) may be coupled to the main body (110) so as to be assembled, and may be coupled to the gun in the form of a slot.

FIG. 4 and FIG. 5 are drawing in which the main body of the camera module and the firearm are connected to an actual firearm.

FIG. 4 is a drawing of the camera module (100) attached to the barrel of the HK416 rifle using the connector (300), and FIG. 5 is a camera attached under the muzzle of the HK416 rifle using the connector (300).

As such, as the connection connector (300) according to the embodiment of the present invention is provided, the camera module (100) can be installed in various firearms, and the camera module can be installed using the connector (300) customized according to the type of the actual firearm or mounting system. (100) can be installed.

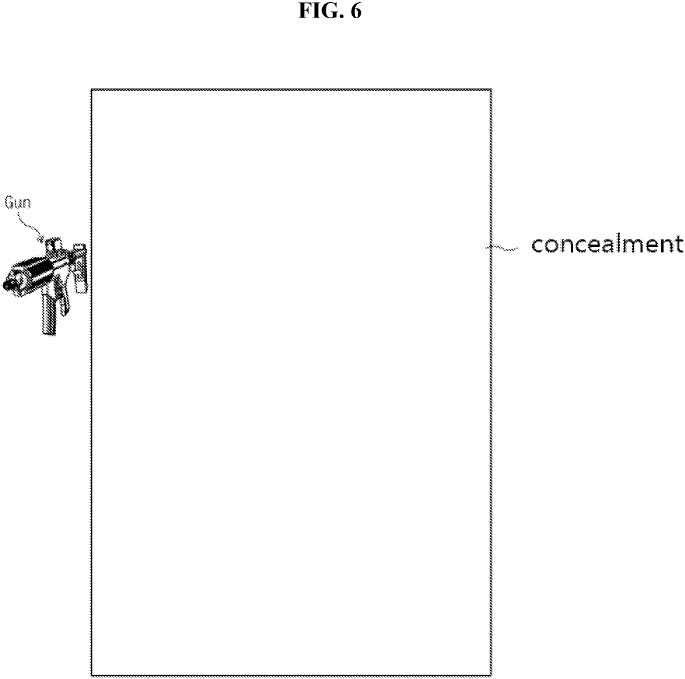

FIG. 6 is a view showing an actual use example of a firearm equipped with a sighting device according to an embodiment of the present invention according to an embodiment of the present invention.

As shown in FIG. 6, when the gun is aimed at a target in a state in which an important part of the body is protected with a concealment, the camera module (100) according to an embodiment of the present invention is mounted on the gun, so that the user can take an image taken through the camera module. The target can be confirmed through the display module (200).

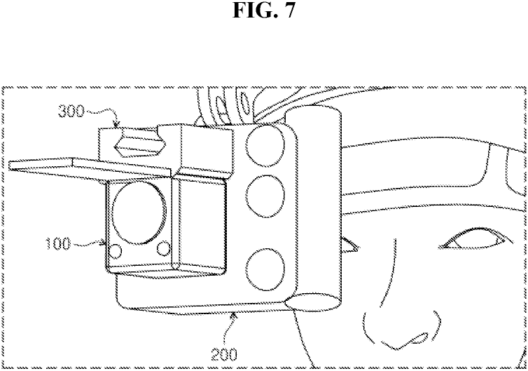

FIG. 7 is a diagram illustrating a combination of a camera module and a display module according to another embodiment of the present invention.

In addition, as shown in FIG. 7, the camera module (100) and the display module (200) according to the embodiment of the present invention each have a connection terminal (not shown) for direct connection, so they are not installed on the firearm, By directly connecting the module, the image captured through the camera module (100) can be configured so that the user can check it through the display module (200).

Furthermore, the accompanying drawings illustrate embodiments of implementation of this invention, but those with ordinary knowledge in the technical field to which it belongs will understand that it can be implemented in other concrete forms without changing its technical ideas or essential features. Therefore, the embodiments described above should be understood to be exemplary and not limited in all respects.

What is claimed is:

1. A sighting device comprising a camera module and a display module,
wherein the camera module comprises main body, photographing unit mounted on the main body to photograph a target, flip cover for opening and closing the open side of the main body, infrared light emitting device installed in a predetermined area of the open side, laser light emitting device installed in a predetermined area of the open side and a first short-range communication module for short-range wireless communication,
wherein the display module comprises screen for reproducing the image captured by the camera module in real time or near real time, manipulation unit for manipulating the image reproduced on the screen and a second short-range communication module communicated with the camera module.

2. The sighting device according to claim 1, further comprising:
a connector coupled to one surface of the main body to connect the main body and the gun.

3. The sighting device according to claim 1, further comprising:
an eye cover attached to the screen to enable monocular aiming.

4. The sighting device according to claim 3,
wherein the eye cover comprises focus lens on the inside.

5. The sighting device according to claim 1,
wherein the camera module further comprises a processor for adjusting a focal length or controlling an operation of the infrared light emitting device or the laser light emitting device and a light receiving sensor for detecting the intensity of a neighboring light.

6. The sighting device according to claim 1,
wherein the camera module further comprises a tilt sensor.
